(19) United States
(12) Patent Application Publication
(10) Pub. No.: US 2016/0325624 A1
(43) Pub. Date: Nov. 10, 2016

(54) FUNCTION CANDIDATE PRESENTATION DEVICE

(71) Applicant: MITSUBISHI ELECTRIC CORPORATION, Tokyo (JP)

(72) Inventors: Reiko SAKATA, Tokyo (JP); Atsushi SHIMADA, Tokyo (JP); Masami AIKAWA, Tokyo (JP); Masato HIRAI, Tokyo (JP)

(73) Assignee: MITSUBISHI ELECTRIC CORPORATION, Tokyo (JP)

(21) Appl. No.: 15/109,150

(22) PCT Filed: Feb. 7, 2014
(86) PCT No.: PCT/JP2014/052907

§ 371 Date: Jun. 30, 2016

(51) Int. Cl. B60K 35/00; B60W 40/08; G01C 21/26; G06N 7/00; G01S 19/13

(52) U.S. Cl. CPC B60K 35/00; G06N 7/005; G01S 19/13; G01C 21/26; B60W 40/08; B60K 2350/1096; B60K 2350/106; B60W 2040/0872

(57) ABSTRACT

A first function likelihood determination unit outputs likelihood of each function candidate based on history. A second function likelihood determination unit outputs likelihood of each function candidate based on predetermined product specifications. A weighting amount determination unit determines weighting amounts for the history and product specifications. A likelihood integration unit integrates, based on the weighting amounts, the likelihood of each function candidate based on the history and the likelihood of each function candidate based on the product specifications. An output unit presents the function candidates in accordance with the integrated likelihood of each of the function candidates.

### TECHNICAL FIELD

The present invention relates to a function candidate presentation device to present function candidates to be executed for a user in accordance with situations. The present invention is applied to, for example, an in-vehicle information device or the like and presents function candidates related to the own vehicle or car navigation operations to a user.

### BACKGROUND ART

In related arts, a function candidate presentation device employs a method such as: calculating the likelihood of a function from the viewpoint of their history; determining by product specifications on which the likelihood of each function is predetermined; or determining in accordance with mode switching. Therefore, there is a problem that functions corresponding to situational changes cannot be presented and thus functions not required by the user are presented.

Therefore, for example, in a device as described in Patent Document 1, with regard to a menu configuration in accordance with a history, the weighting is applied to the history by counting the road state, vehicle state, time period, weekdays, days of the week, or the like, thereby prioritizing an integrated menu.

This device changes weighting of the history by switching modes upon calculating the priorities (likelihoods) of functions from the viewpoint of history.

Furthermore, for example, in Patent Document 2, a device customizes a menu in accordance with use situations. In this device, for means to present a shortcut of a function in accordance with a user history, the mode is designed to be switched such that the function shortcut is determined by the user itself in accordance with the situation (e.g., at the start of using the device).

### CITATION LIST

### Patent Document

### Patent Document 1: JP 2007-71723 A

### SUMMARY OF INVENTION

### Problems to be Solved by the Invention

Under a real travelling situation, however, the situation changes moment to moment and thus the likelihoods of presentation of respective functions is not determined only from the viewpoint of the history, and it is not considered to be possible to present a function suitable to the user's intention unless functions are presented correspondingly to the situation even if the functions have never been operated.

That is, there is a problem that, when changing likelihoods of presentation of functions in accordance with a history of a user, a function that has never been used cannot be presented and functions corresponding to the situation cannot be presented even when the situation is changed.

Furthermore, there is a problem that, in a method to calculate the likelihoods of presentation of functions, in a case where switching between a method based on history and other methods is performed, though it is possible to respond to sudden situational changes, it is not possible to respond to gradual and complex situational changes.

The present invention has been devised in order to resolve the above problems, and an object thereof is to provide a function candidate presentation device capable of flexibly responding to situational changes.

### Means for Solving the Problems

In the present invention, a function candidate presentation device presents function candidates based on likelihoods of a plurality of functions, and includes: a likelihood integrator to integrate the likelihood of each function based on history and the likelihood of each function predetermined in accordance with the situation; and an output device to present function candidates based on the likelihood of each of the functions integrated by the likelihood integrator. Advantageous Effects of Invention

A function candidate presentation device according to the present invention presents function candidates by integrating the likelihood of each function based on the history and the likelihood of each function predetermined in accordance with situations. As a result of such a configuration, it is possible to respond to situational changes flexibly.

### BRIEF DESCRIPTION OF DRAWINGS

FIG. 1 is a diagram illustrating a configuration of a function candidate presentation device according to a first embodiment of the invention;

FIG. 2 is a diagram for explaining a weighting amount table concerning navigation information of the function candidate presentation device according to the first embodiment of the invention;

FIG. 3 is a diagram for explaining a weighting amount table concerning a time in the function candidate presentation device according to the first embodiment of the invention;

FIG. 4 is a flowchart illustrating overall operations of the function candidate presentation device according to the first embodiment of the invention;

FIG. 5 is a flowchart illustrating specification selection processing of the function candidate presentation device according to the first embodiment of the invention;

FIG. 6 shows flowcharts illustrating likelihood integration processing of the function candidate presentation device according to the first embodiment of the invention;

FIG. 7 is a flowchart illustrating a narrowing processing of presenting functions performed by the function candidate presentation device according to the first embodiment of the invention;

FIG. 8 is a diagram explaining an integration result in the case of weekdays provided by the function candidate presentation device according to the first embodiment of the invention;

FIG. 9 is a diagram explaining an integration result in the case of holidays provided by the function candidate presentation device according to the first embodiment of the invention;

FIG. 10 is a diagram illustrating a configuration of a function candidate presentation device according to a second embodiment of the invention;

FIG. 11 shows diagrams for explaining product specifications tables of the function candidate presentation device according to the second embodiment of the invention;

FIG. 12 shows diagrams for explaining weighting amount tables of the function candidate presentation device according to the second embodiment of the invention;

FIG. 13 is a flowchart illustrating overall operations of the function candidate presentation device according to the second embodiment of the invention;

FIG. 14 is a diagram illustrating a configuration of a function candidate presentation device according to a third embodiment of the invention;

FIG. 15 shows diagrams for explaining product specifications tables of the function candidate presentation device according to the third embodiment of the invention;

FIG. 16 is a diagram for explaining a weighting amount table of the function candidate presentation device according to the third embodiment of the invention; and

FIG. 17 is a flowchart illustrating overall operations of the function candidate presentation device according to the third embodiment of the invention.

### MODES FOR CARRYING OUT THE INVENTION

To describe the invention further in detail, some embodiments for carrying out the invention will be described below along the accompanying drawings.

### First Embodiment

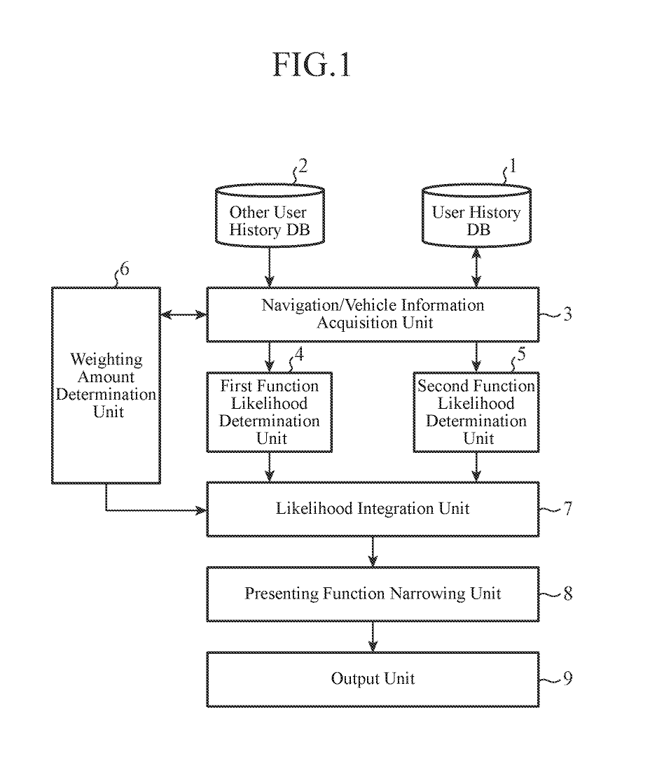

FIG. 1 is a diagram illustrating a configuration of a function candidate presentation device of the present embodiment.

The function candidate presentation device of the present embodiment includes, as illustrated in FIG. 1, a user history database (DB) 1, an other user history database (DB) 2, navigation/vehicle information acquisition unit 3, a first function likelihood determination unit 4, a second function likelihood determination unit 5, a weighting amount determination unit 6, a likelihood integration unit 7, a presenting function narrowing unit 8, and an output unit 9. Note that, in the present embodiment, the function candidate presentation device is explained as a device to perform information presentation based on information from a car navigation device installed on the vehicle, and/or an in-vehicle information device such as a radio or a device for reproducing music or videos.

The user history database 1 stores a history of function selecting (an operation history of functions, a use history of functions) by a user using (operating) the function candidate presentation device. For example, the user history database 1 stores an operation history of a car navigation device, operation history of an audio device, operation history of an air conditioner, and travelling history. Furthermore, the other user history database 2 stores histories of other users.

The navigation/vehicle information acquisition unit 3 acquires history information of a user while linked with a car navigation device or the like. The history information is classified by operation states of, for example, Global Positioning System (GPS) signals transmitted by the GPS satellites, a vehicle information device, the position of the own vehicle, and a travelling route. This history information is accumulated in the user history database 1 as well as notified to the first function likelihood determination unit 4.

Moreover, the navigation/vehicle information acquisition unit 3 may be preferably designed to complement the history information by referring to the other user history database 2 in a situation new to the user such as: no history of the user operation exists in the car navigation device or the like; or the present travelling route is new to the user. Here, the other user history database 2 is, for example, an accumulation of use histories of a number of users obtained in advance in a development phase, and is a use history DB corresponding to a time period, destination set point, or type of a travelling road, such as “a use history during travel on national roads”, “a use history during travel from home to a leisure facility”, “a use history during travel from a commercial facility to home”, and “a use history during travel to a workplace in the early morning”. The other user history database 2 is not a necessary component for the present invention and referred to by the navigation/vehicle information acquisition unit 3 as required. Note that, the other user history database 2 may be held in the function candidate presentation device in advance as a database in which data therein is periodically updated. Alternatively, the other user history database 2 may be provided in a server or the like to which the function candidate presentation device is communicably connected, wherein the function candidate presentation device performs communication connection to acquire data as required.

The first function likelihood determination unit 4 refers to the history information obtained from the navigation/vehicle information acquisition unit 3 and calculates the likelihood of each function used by a user in accordance with situations (conditions). That is, for a function that is estimated to have a high probability of use by the user in a certain situation, the likelihood of the function is determined to be high. Higher likelihood is given to, for example, functions which is frequently used by a user, and functions for which the user performs an operation at an early step of sequence after activation of the device. Also, a lower likelihood is given to, for example, a function whose operation has failed before, and a function which has a record of operation in a history and is presented before but not used. The accumulation of history may be performed not only by simply accumulating an operation history, but by accumulating an operation history by each category such as, for example, an operation history corresponding to travelling situations of a vehicle like travelling on a highway or on a general road, and an operation history categorized by each day of the week. The likelihood of the history may be calculated using such an operation history by each category.

Note that, when the likelihood is calculated as a numerical value, it is possible to consider the following methods: several steps are given within a certain point range (e.g. 0 to 10 points) for each function; and the total point of all functions are assumed to be constant and the total point is distributed to each of the functions. The calculated likelihood of each function based on the history is notified to the likelihood integration unit 7.

Moreover, in an initial state in which the history in the user history database 1 is poor, the first function likelihood determination unit 4 may communicate a signal indicating such a state to the second function likelihood determination unit 5, or may acquire an operation history in the other user history database 2 from the navigation/vehicle information acquisition unit 3 and calculate the likelihood of each function based on the history.

The second function likelihood determination unit 5 determines the likelihood of functions predetermined correspondingly to each situation (condition) based on product specifications. The specifications specify situations, functions, and likelihoods which are linked to each other. That is, for example, one or more function candidates are associated with a certain situation and a likelihood is defined for each of the function candidates. Here, the “situation” in the present embodiment includes at least one of a type of destination and travelling situation. The second function likelihood determination unit 5 specifies the type of destination based on conditions such as, whether a destination is set or not, the genre of the destination, whether the destination has been visited before, the time period of a day when the destination is set, and rough distance to the destination. Further, a travelling situation is specified based on conditions such as a start point, the remaining time to the arrival at the destination, time passed from the start point, remaining time to a highway travel on the route, and a type of road currently travelling on. The type of destination indicates, for example, leisure in a distant place visiting for the first time, commuting, giving a lift, and outing on a train. The travelling situation indicates, for example, a vicinity of the destination, travelling on a highway, and starting from home.

The second function likelihood determination unit 5 selects function candidates predetermined by product specifications corresponding to at least one of the type of destination and travelling situation obtained in the above manner. In other words, product specifications in accordance with the situation is selected. For example, when the type of destination is “commuting”, product specifications specifying “play radio” is selected as a function candidate with the highest likelihood. When the travelling situation is “in a vicinity of the destination”, product specification specifying “enlarge the map” is selected as a function candidate with the highest likelihood. Since situations, functions, and likelihoods are specified to be linked to each other, by selecting product specifications in the above manner, the likelihoods of functions corresponding to each situation are specified, thereby function candidates can be selected. Moreover, when the second function likelihood determination unit 5 receives the signal indicating that the likelihood of each function cannot be calculated based on the history because the history is poor from the first function likelihood determination unit 4, specifications corresponding to the present situation can be selected.

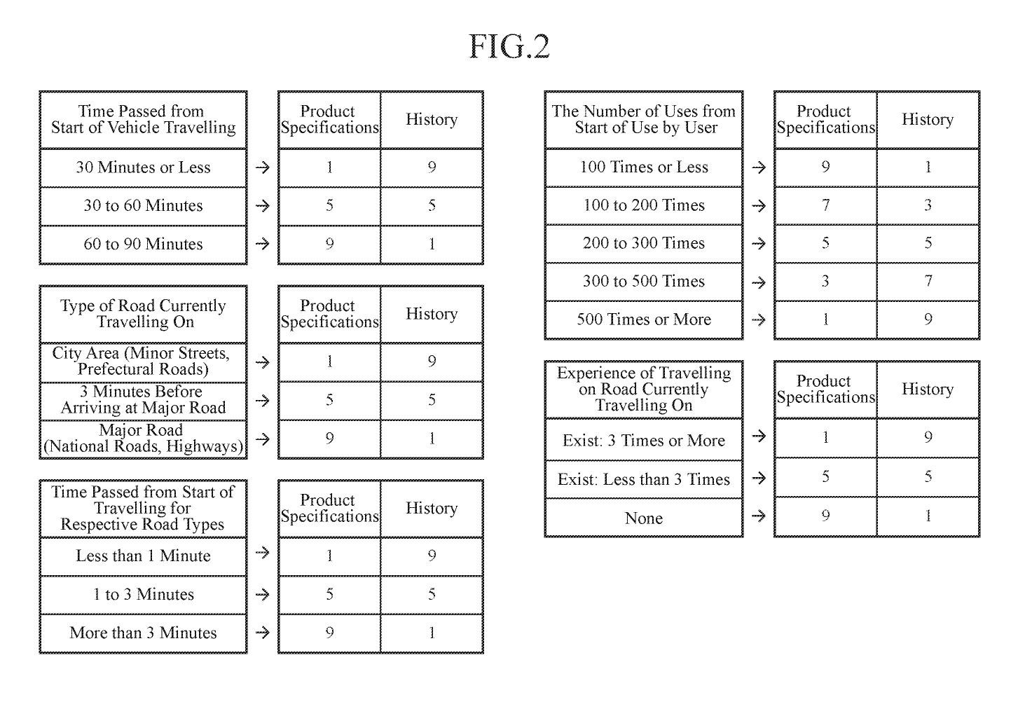

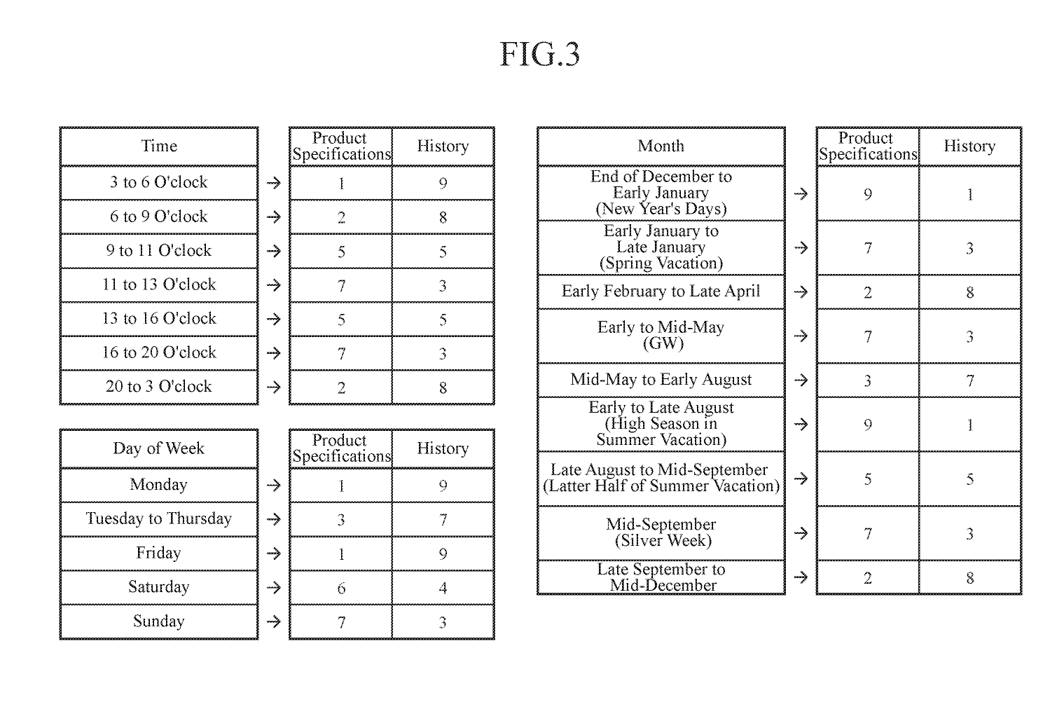

The weighting amount determination unit 6 determines weighting amounts for histories or product specifications in accordance with signals of histories and vehicle information received from the navigation/vehicle information acquisition unit 3. The weighting amount determination unit 6 has a plurality of weighting amount tables. The weighting amount tables is exemplified by the one concerning navigation information, the one concerning time, or the like. Some examples of table patterns are illustrated in FIGS. 2 and 3.

FIG. 2 shows weighting amount tables concerning navigation information, which relate to information obtained from a car navigation device or vehicle information device. For example, when the time passed from the start of travelling of a vehicle is short, the weighting amount for each function candidate based on the history, output from the first function likelihood determination unit 4, is raised. Moreover, in a city area, a larger weighting amount is set to function candidates based on the history output from the first function likelihood determination unit 4. Note that, since the user is accustomed to drive under a situation such as the start of driving or in a city area so that function candidates based on the history is considered to be selected at high possibility, the weighting amounts of the function candidates based on the history are set to be large. From such a kind of viewpoints, settings are made such as “vary the weighting amount in accordance with the number of uses from the start of use of the function by the user”, “vary the weighting amount in accordance with the time passed from the start of travelling of the vehicle”, and “vary the weighting amount in accordance with the frequency of travelling on the road, where the vehicle is currently travelling on, in the past”.

Furthermore, FIG. 3 illustrates weighting amounts concerning time. The illustrated tables are configured to determine weighting amounts by ranges such as by time (time period), day of the week, and month. Here, for example by time, in the time periods of 3 to 6 o'clock or 6 to 9 o'clock, since many of the operations are assumed to be ones which are generally performed by the user such as daily commuting, the weighting amounts of function candidates based on the history is raised. Also, on holidays such as Saturdays and Sundays, the weighting amounts are determined from the viewpoint as follows: since it is considered that a driver who drives only on holidays may use the device, the weighting amounts based on product specifications are raised by a certain amount. Moreover, the weighting amounts by month are determined from the viewpoint of whether a holiday is a general holiday such as the new years' vacation or summer vacation. For example, a driver who does not drive usually may drive during a high season of a long vacation period such as the new years' vacation or a high season of summer vacation. Therefore, the weighting amounts based on product specifications are set to be large.

The weighting amounts of the weighting amount determination unit 6 may be set, for example, by using numerical values as follows: the sum of the weighting amounts based on the history and product specifications becomes a constant value; and each weighting amount is set to one of figures indicating steps such as 1 to 5, and if the sum of the weighting amounts based on the history and product specifications is less than a predetermined value, the remnant value from the sum to the predetermined value is used to raise the weighting amount of the selection of the function of “not present a function”. In the weighting amount tables illustrated in FIG. 2, the total value of the feature values of weighting amounts based on product specification and history, which are described in integers, becomes 10 for respective conditions. The weighting amount may be a value that transits among the feature values in accordance with conditional changes, or a product of values of the respective conditions in the table when the conditions overlap to each other. Here, the product of values in the table means to take an average of weighting amounts. For example, on Monday in early August to late August, the product specifications are weighted by 9*1=5 while the history is weighted by 9*1=5.

The likelihood integration unit 7 reflects the weighting amounts determined by the weighting amount determination unit 6 to each of the likelihood of the function based on history and the likelihood of the function based on product specifications and integrates them. Based on this integration, the likelihood of each function is calculated. The calculated likelihood is notified to the presenting function narrowing unit 8. When the integration processing is performed by numerical values, each of the value of the history and the value of the product specifications are multiplied by the numerical values calculated by the weighting amount determination unit 6, and the integration is performed by summing the multiplied results.

The presenting function narrowing unit 8 narrows functions to be presented based on the likelihood of each of the functions calculated by the likelihood integration unit 7. The narrowing may be performed preferably by, for example, selecting several functions ranked high when the likelihood is represented by a numerical value. When there is a lot of corresponding functions, functions to be presented may be narrowed with reference to the weighting amounts from the weighting amount determination unit 6. The narrowed functions are notified to the output unit 9.

The output unit 9 presents function candidates. Output methods include displaying on a screen, outputting voice, or the like. In either way, functions of higher likelihood are displayed at positions easier to recognize for the user and, when displayed in a line, arranged from a direction where a higher level concept is displayed, that is, e.g., displayed in an upper position when selection is made from upper item or displayed on the left side when selection is made from item on the left. Moreover, highlighting, representation, order are provided with an object to prompt a user to a use in such a manner as to provide an icon, display in a highlighted color, provide voice presentation in advance, or the like.

Note that, the function candidate presentation device of the present invention is implemented by a computer and the navigation/vehicle information acquisition unit 3 to the presenting function narrowing unit 8 are configured by software corresponding to each of the functions thereof and hardware such as CPU or memory to execute such software. Alternatively, a functional unit of at least one of the navigation/vehicle information acquisition unit 3 to the presenting function narrowing unit 8 may be configured by dedicated hardware.

Next, operations of the function candidate presentation device of the first embodiment will be described.

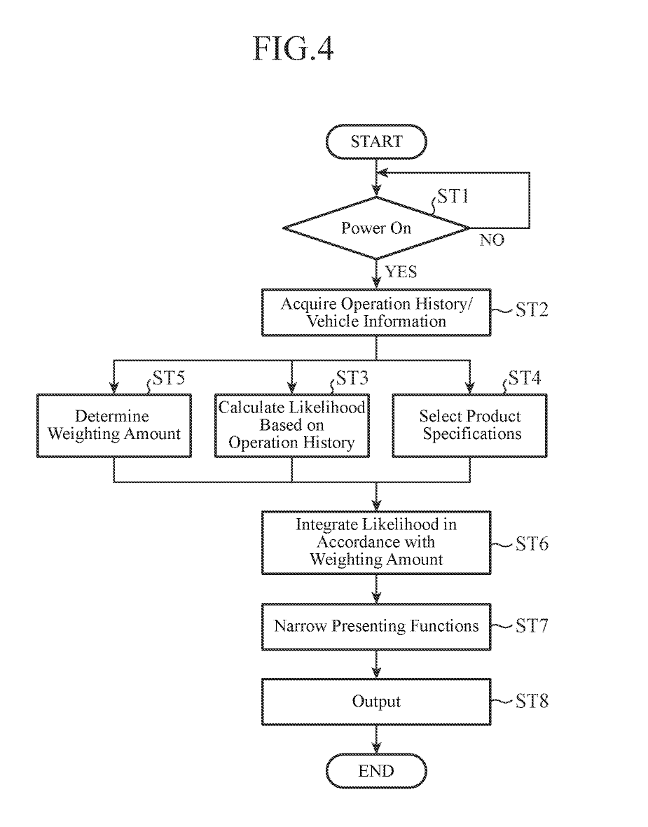

FIG. 4 is a flowchart illustrating overall operations of the function candidate presentation device.

When a power source of the function candidate presentation device is turned on (step ST1), the navigation/vehicle information acquisition unit 3 acquires operation history/vehicle information (step ST2). That is, navigation information such as the user history of the in-vehicle information device, the present location, the genre of the destination, the remaining time to the arrival at the destination, the type of the road currently travelling on, or traffic jam information is acquired by referring to a vehicle information device, car navigation device, GPS signals, traffic jam information signals, or the Internet DB.

Here, when the operation history of the user is poor based on the navigation information of the user, it is possible to complement the user's history with history of other users by referring to the other user history database 2.

Next, the likelihood calculation processing based on the operation history by the first function likelihood determination unit 4 (step ST3) and the specifications selection processing by the second function likelihood determination unit 5 (step ST4) are performed.

In the likelihood calculation processing based on the operation history in step ST3, the likelihood of each function based on history is calculated by referring to the history of the car navigation device, the history of the in-vehicle information device, or the like. Here, there is a case that the likelihood based on history cannot be calculated because, for example, the history is poor at the start of use of the product. In such a case, it is preferable to transmit information indicating that the likelihood based on history cannot be calculated to the second function likelihood determination unit 5, or to perform the calculation based on the history complemented by the other user history database 2.

In the selection processing of product specifications in step ST4, the product specifications is selected based on information of the destination or travelling situation acquired from the navigation/vehicle information acquisition unit 3 such as whether the destination is set or not, a genre of the destination, the presence or absence of experience of visiting the destination in the past, time period upon setting the destination, rough distance to the destination, start point, the remaining time to the arrival at the destination, time passed from the start point, the remaining time to travelling on a highway on the route, and the type of the currently travelling road. Moreover, when a signal showing that the likelihood based on history cannot be calculated is received from the first function likelihood determination unit 4, the specifications corresponding to the case where the likelihood based on history does not exist is selected. Details of this specifications selection processing will be described later.

Furthermore, the weighting amount determination unit 6 determines weighting amounts (step ST5). That is, the weighting amount determination unit 6 calculates the weighting amounts corresponding to the history/vehicle information by referring to the weighting amount tables illustrated in FIG. 2 and FIG. 3. The calculated weighting amounts are transmitted to the likelihood integration unit 7.

The likelihood integration unit 7 integrates the output from the first function likelihood determination unit 4 and the output from the second function likelihood determination unit 5 based on the weighting amounts determined by the weighting amount determination unit 6 (step ST6). Details of this integration processing will be described later.

Next, narrowing processing of presenting functions is performed (step ST7). That is, functions to be presented to the user are narrowed in accordance with the likelihood of each of the functions transmitted from the likelihood integration unit 7 and the result is transmitted to the output unit 9. Details of this presenting function narrowing processing will also be described later.

Next, functions are presented as an output to the user (step ST8). That is, the output unit 9 outputs the functions narrowed by the presenting function narrowing unit 8. The output may be display output on a screen or voice output. In this manner, the main processing of the function candidate presentation device ends.

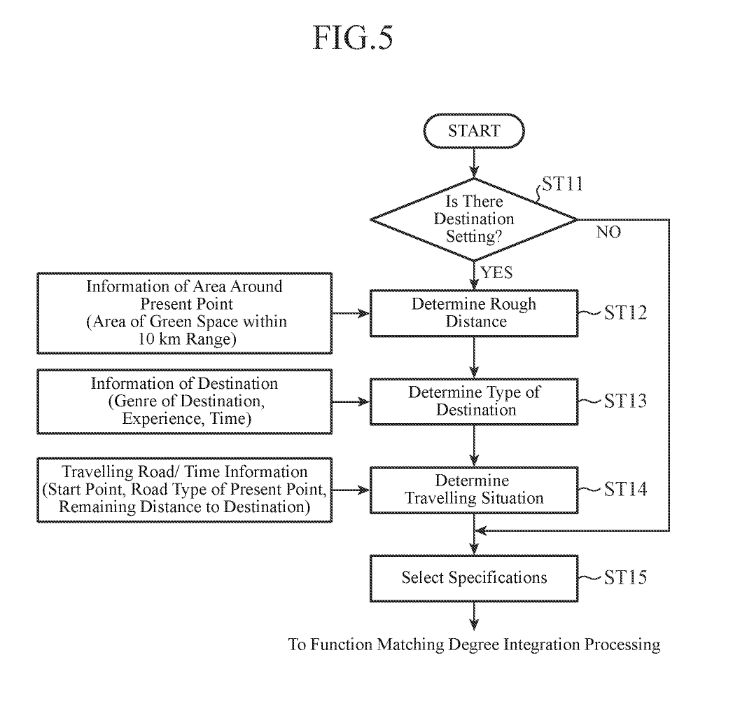

Details of the specifications selection processing in the aforementioned step ST4 will be described below with reference to the flowchart illustrated in FIG. 5.

In the specifications selection processing, firstly, whether a destination is set or not is determined (step ST11). If a destination is not set, specifications for the case of no set destination are selected (step ST15). On the other hand, if the destination setting exists in step ST11, specifications are selected in the following procedure. First, a rough distance is determined from information of the vicinity of the present location (step ST12). Next, a type of destination is determined from information of the destination and the rough distance (step ST13). Next, the travelling situation is determined from the travelling road/time information (step ST14). Specifications are selected based on the type of destination and travelling situation obtained in the above manner (step ST15).

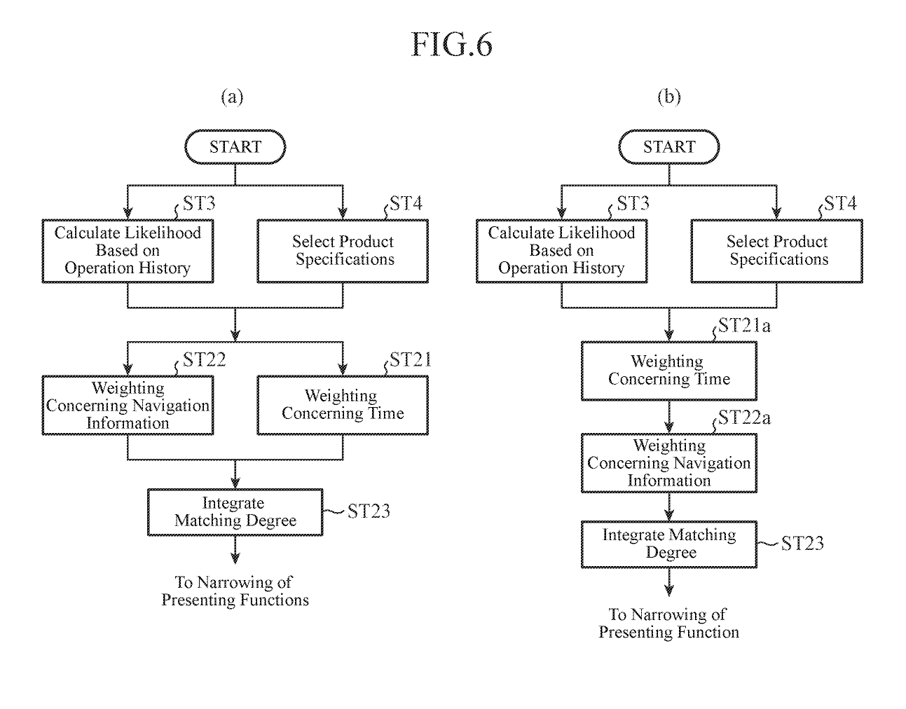

Next, details of the likelihood integration processing will be described with reference to flowcharts illustrated in FIGS. 6(a) and 6(b).

In the likelihood integration processing, weighting is performed on each of the likelihood of function based on the history and the likelihood of function based on the product specifications using weighting amounts concerning navigation information and weighting amounts concerning time. This weighting is preferably performed by any of the following two methods. In the method shown in FIG. 6(a), the likelihood is integrated by multiplying each of the likelihood based on the history obtained by step ST3 and the likelihood based on the product specifications obtained by step ST4 simultaneously by the weighting amounts concerning navigation information and weighting amounts concerning time (step ST21 to step ST23). In the method shown in FIG. 6(b), the likelihood is integrated by multiplying each of the likelihood based on the history obtained by step ST3 and the likelihood based on the product specifications obtained by step ST4 by the weighting amounts concerning time and weighting amounts concerning navigation information in a certain order (step ST21a to step ST23) (FIG. 6(b)).

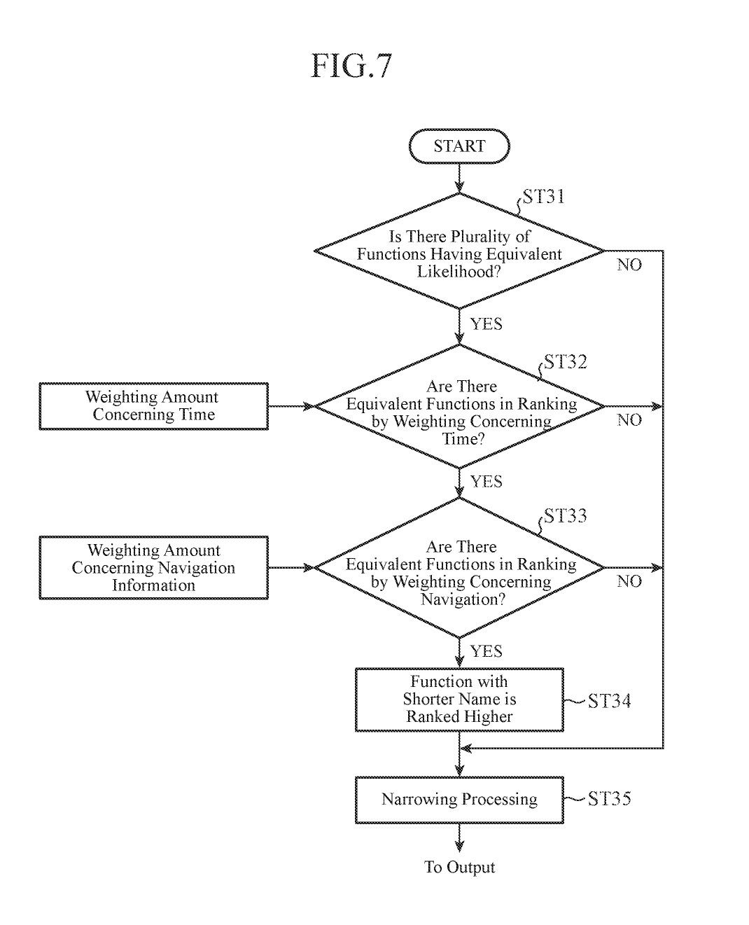

Next, details of the presenting function narrowing processing will be described with reference to the flowchart illustrated in FIG. 7.

In the presenting function narrowing processing, narrowing is performed based on the likelihood of each function. First, whether there are functions having likelihoods equivalent to each other or not is determined (step ST31). If there are no functions having equivalent likelihoods, narrowing processing is performed based on the ranking of likelihood (step ST35). On the other hand, if there are functions having equivalent likelihoods in step ST31, ranking is provided to the likelihood in the following procedure. That is, a ranking is provided by referring to the weighting amounts concerning time and weighting amounts concerning navigation information (steps ST32 and ST33). Next, if a ranking is not provided even in the above manner, a function with a shorter name is ranked higher (step ST34) and narrowing processing is thereby performed (step ST35).

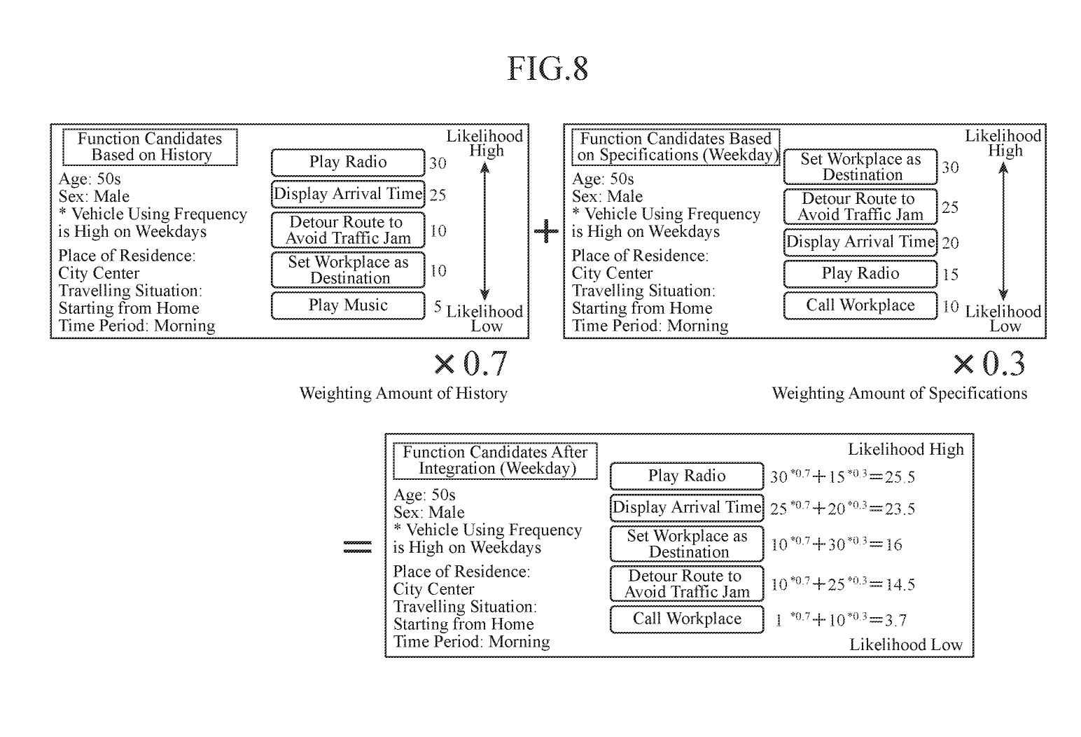

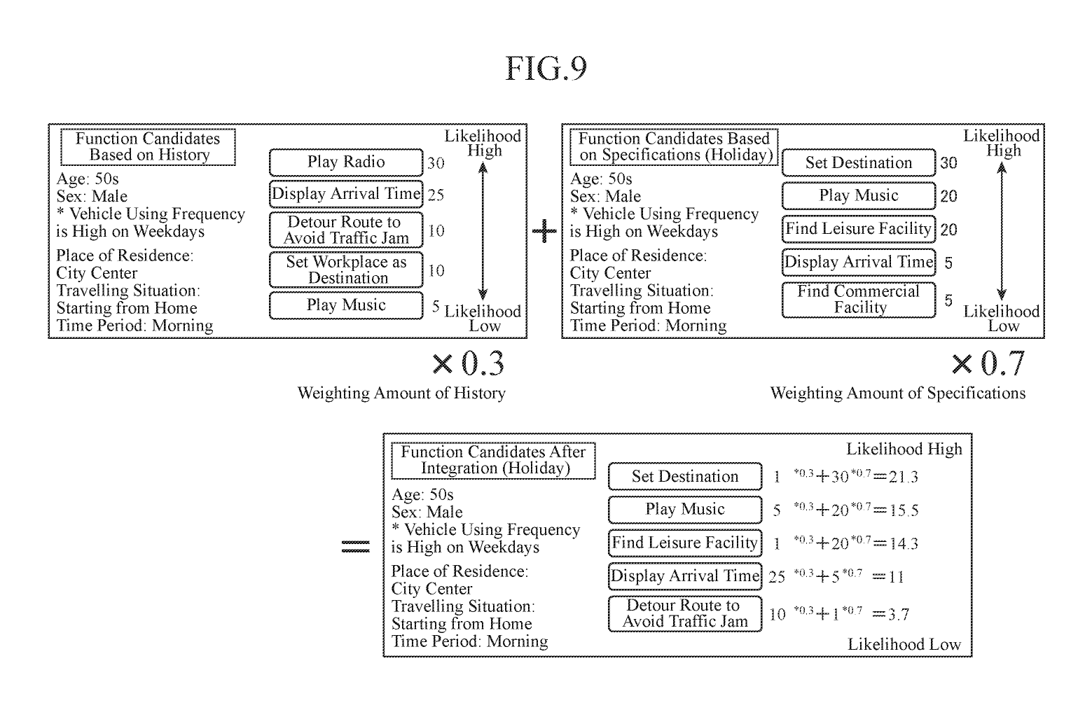

An integration result in a case of weekday is illustrated in FIG. 8, and an integration result in a case of holiday is illustrated in FIG. 9. These illustrative examples represent a case of a user who uses a vehicle frequently on weekdays (in particular, travelling for “own commuting”). For example, the weighting amount for history is 0.7 while the weighting amount for product specifications is 0.3 on weekdays and thus higher priority is provided to function candidates based on the history. And thus, “play radio” having the highest likelihood among the function candidates based on the history becomes the function candidate having the highest likelihood without change. On the other hand, the weighting amount for history is 0.3 while that for the product specifications is 0.7 in the case of holidays illustrated FIG. 9, and thus higher priority is provided to function candidates based on the product specifications. Thus, “set destination” having the highest likelihood among the function candidates based on the product specifications becomes the function candidate having the highest likelihood without change.

As described above, a function candidate presentation device according to the first embodiment which presents function candidates based on the likelihood of each of the plurality of functions includes: a likelihood integration unit to integrate the likelihood of each function based on the history and the likelihood of each function predetermined in accordance with the situations; and an output unit to present function candidates based on the likelihood of each function integrated by the likelihood integration unit. As a result of this configuration, it is possible to provide a likelihood to a function which has never been used by the user, and it is possible to flexibly respond to situational changes.

Furthermore, the function candidate presentation device of the first embodiment includes a weighting amount determination unit to determine weighting values for the likelihood of each function based on the history and the likelihood of each function predetermined in accordance with the situation based on information based on a travelling situation of the vehicle and information based on day and time. Further, the likelihood integration unit is configured to integrate the likelihood based on the weighting values of the weighting amount determination unit. Therefore, it is possible to give the likelihoods of function candidates and display/expression/order to present functions respective levels in accordance with the travelling situation that changes moment to moment. As a result, an expression of a gradually changing function presentation for a user can be achieved. In particular, in the case of an in-vehicle display device during driving, an expression which does not give surprise to a driver as possible can be provided, which contributes to safe driving.

Also, according to the function candidate presentation device of the first embodiment, the weighting amount determination unit is configured to determine the weighting amounts based on at least one piece of information of the time passed from the start of travelling, the road type of the road currently travelling on, the time passed from the start of travelling on respective road types, the number of uses from the start of use by a user, and the presence or absence of experience of travelling on the currently travelling road. As a result, presentation of functions intended by the user can be performed more appropriately.

Moreover, according to the function candidate presentation device of the first embodiment, the weighting amount determination unit is designed to determine the weighting values based on at least one piece of information of a time period in a day, a day of the week, and a period in a year. Therefore, presentation of functions intended by the user can be performed more appropriately.

Furthermore, according to the function candidate presentation device of the first embodiment, histories of other users are included for use as the history. Consequently, presentation of functions that are not unnatural for the user can be provided even in a situation where no history is accumulated.

### Second Embodiment

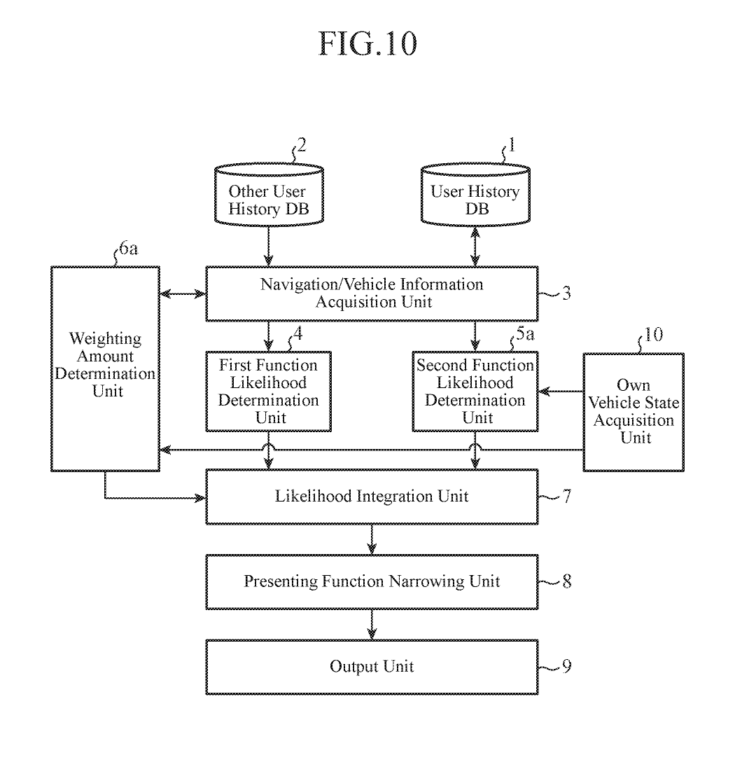

FIG. 10 is a diagram illustrating a configuration of a function candidate presentation device of a second embodiment.

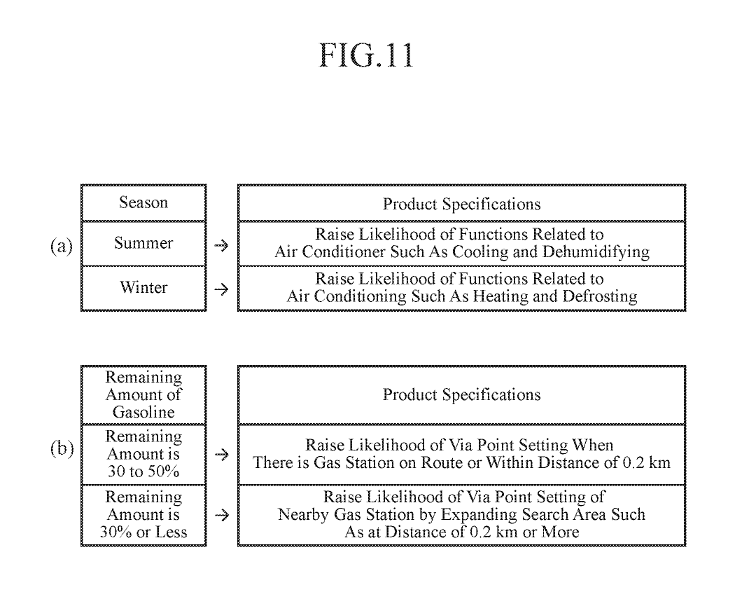

The function candidate presentation device of the second embodiment includes a user history database 1, other user history database 2, navigation/vehicle information acquisition unit 3, first function likelihood determination unit 4, second function likelihood determination unit 5a, weighting amount determination unit 6a, likelihood integration unit 7, presenting function narrowing unit 8, output unit 9, and own vehicle state acquisition unit 10. The own vehicle state acquisition unit 10 is a processing unit to acquire values representing vehicle states. Here, the own vehicle state is information such as “the temperature in the vehicle” or “the remaining amount of consumables such as gasoline”. The second function likelihood determination unit 5a further includes product specifications tables of the own vehicle state as illustrated in FIGS. 11(a) and 11(b) in addition to the product specifications tables of the first embodiment.

The product specifications table illustrated in FIG. 11(a) corresponds to the temperature in the vehicle with a product specifications to “raise the likelihood of each function related to air conditioning such as a cooling system and dehumidifier” at a high temperature (summer) and a product specifications to “raise the likelihood of each function related to air conditioning such as a heating system and defroster” at a low temperature (winter). Moreover, the table illustrated in FIG. 11(b) includes product specifications corresponding to the remaining amount of gasoline with a product specifications to, for example, “raise likelihood of via point setting of a nearby gas station by expanding a search area such as at distance of 0.2 km or more” when the remaining amount is small.

The second function likelihood determination unit 5a is configured to select product specifications based on a value acquired by the own vehicle state acquisition unit 10 with reference also to such product specifications tables.

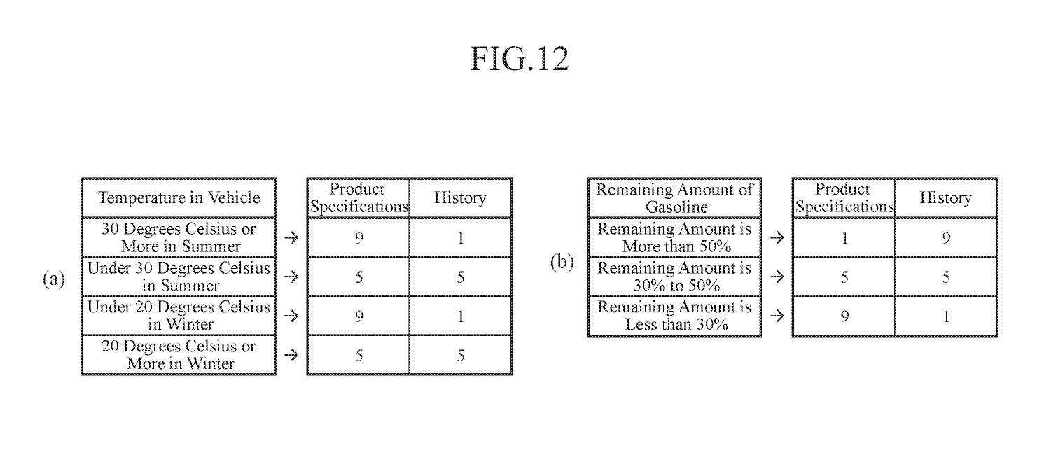

The weighting amount determination unit 6a further includes weighting amount tables as illustrated in FIGS. 12(a) and 12(b) in addition to the weighting amount tables of the first embodiment. The illustrated weighting amount tables include settings such as, as illustrated in FIG. 12(a), to raise the weighting value for product specifications when it is hot in summer or cold in winter, or, as illustrated in FIG. 12(b), to raise the weighting value for product specifications when the remaining amount of gasoline is small. The weighting amount determination unit 6a is configured to determine weighting values for product specifications and history based on the value acquired by the own vehicle state acquisition unit 10 with reference also to such weighting amount tables.

Other configurations in FIG. 10 are similar to those of the first embodiment and thus descriptions here are omitted.

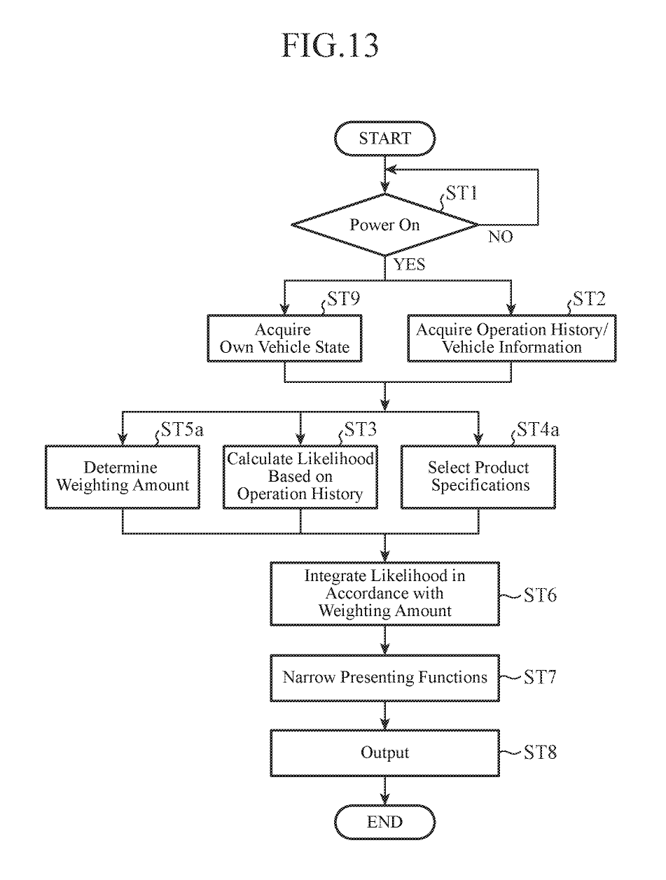

Next, operations of the function candidate presentation device of the second embodiment will be described with reference to the flowchart of FIG. 13. In FIG. 13, step ST1 to step ST3 are similar to those of the first embodiment. In the second embodiment, when a power source of the function candidate presentation device is turned on, the own vehicle state acquisition unit 10 acquires own vehicle information such as a temperature in the vehicle or remaining amounts of consumables (step ST9). Based on the acquired information, the second function likelihood determination unit 5a selects product specifications while also using the product specifications tables illustrated in FIGS. 11(a) and 11(b) (step ST4a). Moreover, the weighting amount determination unit 6a determines weighting values for the likelihood of each function based on product specifications and the likelihood of each function based on history using the weighting amount tables as illustrated in FIGS. 12(a) and 12(b) (step ST5a). The subsequent operations (steps ST6 to ST8) are similar to those of the first embodiment and thus descriptions thereof are omitted.

As described above, according to the function candidate presentation device of the second embodiment, at least one of vehicle state information and season information is included as the situation. Thus, a likelihood having been set as product specifications can be gradually raised in accordance with the vehicle state such as increase of temperature or decrease of remaining amount of gasoline. Therefore, it is possible to give the likelihoods of function candidates and display/expression/order to present functions respective levels. Consequently, an expression of a gradually changing function presentation for a user can be achieved.

### Third Embodiment

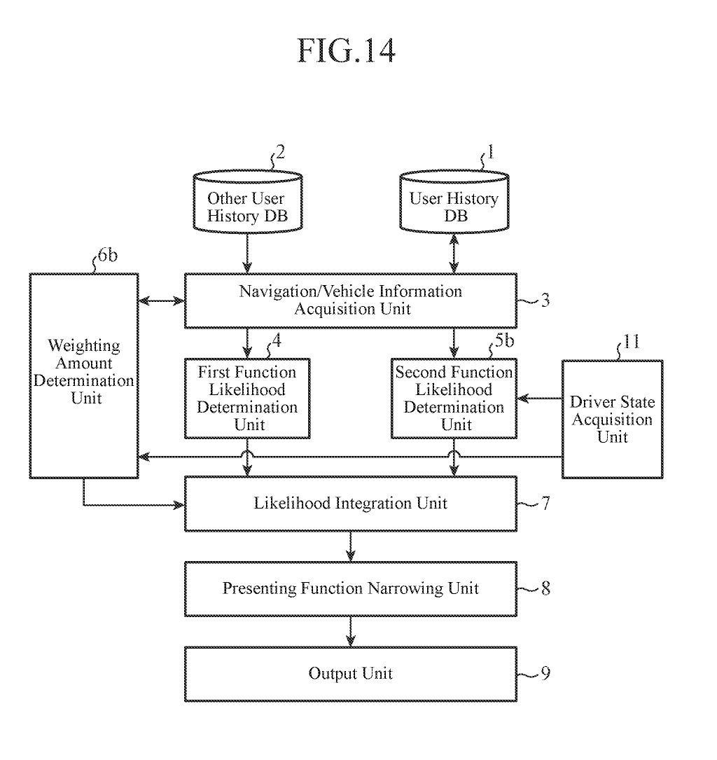

FIG. 14 is a diagram illustrating a configuration of a function candidate presentation device of a third embodiment.

The function candidate presentation device of the third embodiment includes a user history database 1, other user history database 2, navigation/vehicle information acquisition unit 3, first function likelihood determination unit 4, second function likelihood determination unit 5b, weighting amount determination unit 6b, likelihood integration unit 7, presenting function narrowing unit 8, output unit 9, and driver state acquisition unit 11. The driver state acquisition unit 11 is a processing unit to acquire values representing a state of a vehicle driver. Here, the driver state includes, for example, information such as “sight line focusing part” and “autonomic nervous activity”. A method to detect the driver state may be to measure physiological reactions of the driver. In this case, measurement is made in a contactless manner or a measuring method with less burden on a driver as possible such as measuring autonomic nervous activities or nose skin temperature. Existing methods are used as the measuring method in this embodiment. For example, as a specifying method of a sight line focusing part, a known technique is applicable such as to determine the part based on an image capturing a face part of the driver. Also, as a method to specify autonomic nervous activities of the driver, for example, fluctuation of pulse waves of the driver can be measured by a sensor ring at fingertips or ear lobes. In particular, in a case of an in-vehicle device, it is considered to install a fingertip sensor in a steering wheel part. By performing measurement by this fingertip sensor, burden on the subject can be eliminated. Moreover, autonomic nervous activities can be implemented using a device such as a heart rhythm scanner to perform a heart rate fluctuation analysis.

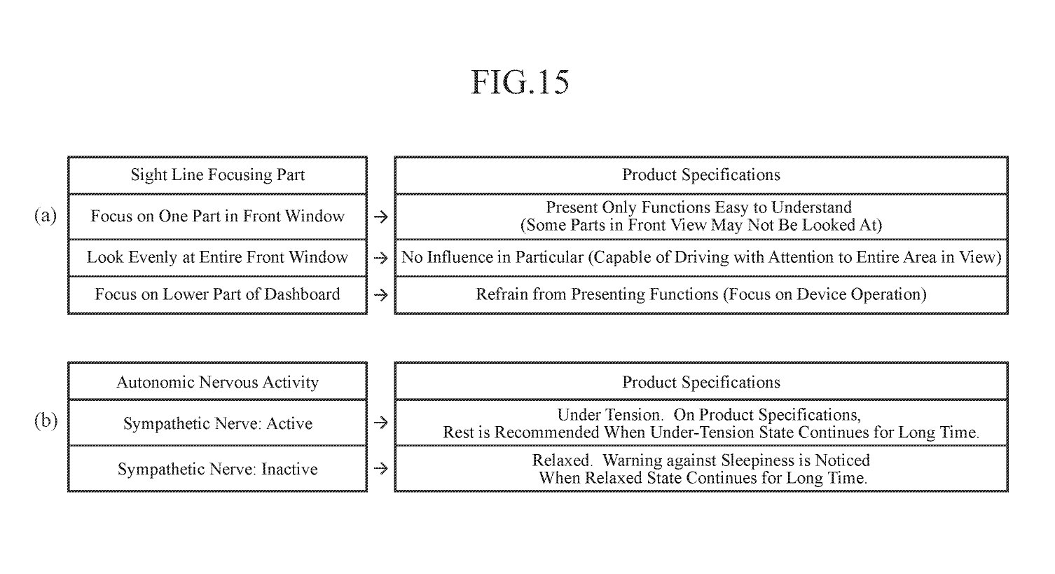

The second function likelihood determination unit 5b further includes product specifications tables of the own vehicle state as illustrated in FIGS. 15(a) and 15(b) in addition to the product specifications tables of the first embodiment. In the product specifications corresponding to sight line focusing parts illustrated in FIG. 15(a), for example, when the sight line is “focused at one part in the front window”, the product specifications are set to present only functions that are easy to understand since some parts in the front view may not be looked at. Furthermore, when the autonomic nervous activity illustrated in FIG. 15(b) is “sympathetic nervous active”, this shows an on-tension state and thus the product specifications are to recommend to rest when such an on-tension state continues for a long time.

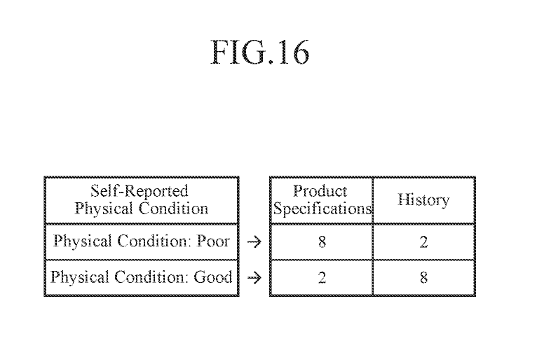

Also, the weighting amount determination unit 6b further includes a weighting amount table as illustrated in FIG. 16 in addition to the weighting amount tables of the first embodiment and determines weighting amounts concerning product specifications and history while also using this weighting amount table. The illustrated weighting amount table includes settings where a weighting amount for product specifications is larger when the self-reported physical condition is poor and a weighting amount for history is larger when the self-reported physical condition is good.

Other configurations in FIG. 14 are similar to those of the first embodiment and thus descriptions here are omitted.

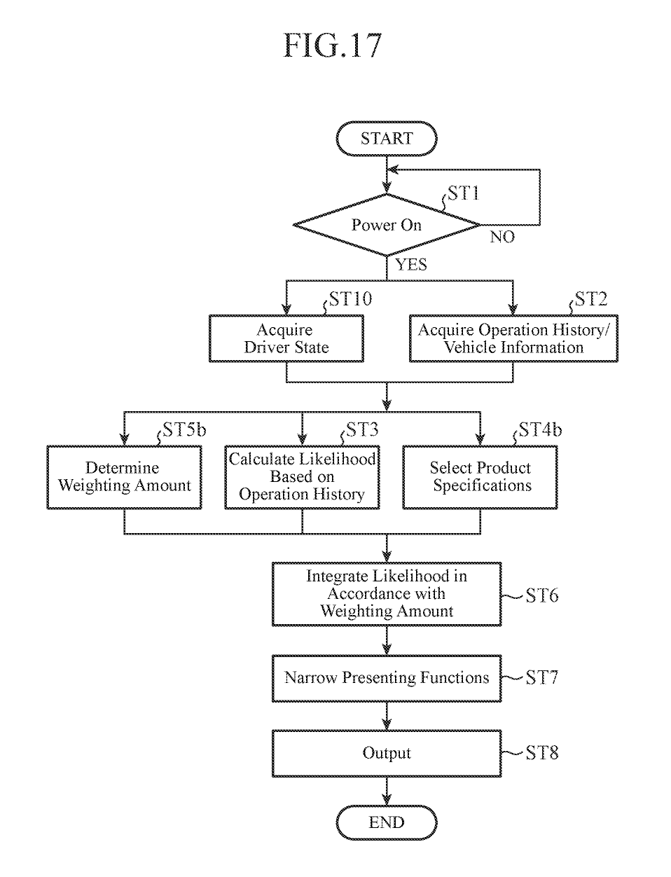

Next, operations of the function candidate presentation device of the third embodiment will be described with reference to the flowchart in FIG. 17. In FIG. 17, step ST1 to step ST3 are similar to those of the first embodiment. In the third embodiment, when a power source of the function candidate presentation device is turned on, the driver state acquisition unit 11 acquires information of the driver (step ST10). Based on the acquired information, the second function likelihood determination unit 5b selects product specifications while also using the product specifications tables illustrated in FIGS. 15(a) and 15(b) (step ST4b). Moreover, the weighting amount determination unit 6b determines weighting values for the likelihood of each function based on product specifications and the likelihood of each function based on history using weighting amount tables as illustrated in FIG. 16 (step ST5b). The subsequent operations (steps ST6 to ST8) are similar to those of the first embodiment and thus descriptions thereof are omitted.

Note that, the proficiency of a driver as to whether the driver is a beginner or skilled driver may be estimated based on information such as operations of the steering wheel or brake or travelling patterns, and this proficiency may be used as the driver state.

As described above, according to the function candidate presentation device of the third embodiment, the driver state is used as a situation and thus, for example, the likelihood of each function which is considered to be required for the driver can be raised gradually by, for example, warning or recommendation of rest, when the sight line focusing part of the driver is gradually focused at one part or the driver, or when the driver starts to feel sleepiness. This allows for raising attention of the driver not in an abrupt manner but in a step-by-step manner and thus presentation of functions can be performed by display/expression/order which contributes to safer driving.

Note that, in the function candidate presentation device of each of the aforementioned embodiments, some examples are explained in which the device is applied to an in-vehicle device such as a car navigation device or in-vehicle information device; however, the function candidate presentation device is not limited thereto but may be applied to any device as long as the device presents functions based on the likelihoods of a plurality of functions.

Note that, within the scope of the present invention, the present invention may include a flexible combination of the respective embodiments, a modification of any component of the respective embodiments, or an omission of any component in the respective embodiments.

### INDUSTRIAL APPLICABILITY

In this manner, the function candidate presentation device according to the present invention determines function candidates to be presented by integrating the likelihood of each function based on history and the likelihood of each function predetermined in accordance with situations when function candidates are to be presented, and thus is suitable for use in a device such as an in-vehicle information device or car navigation device.

### REFERENCE SIGNS LIST

1 user history database
2 other user history database
3 navigation/vehicle information acquisition unit
4 first function likelihood determination unit
5, 5a, 5b second function likelihood determination unit
6, 6a, 6b weighting amount determination unit
7 likelihood integration unit
8 presenting function narrowing unit
9 output unit
10 own vehicle state acquisition unit
11 driver state acquisition unit

1-8. (canceled)

9. A function candidate presentation device to present function candidates based on a likelihood of each of a plurality of functions, the device comprising:
a weighting amount determinator to determine weighting values, wherein one of the weighting values is for the likelihood of the function based on history and another one of the weighting value is for the likelihood of the function predetermined in accordance with a situation, based on information based on travelling situation of a vehicle and information based on day and time;
a likelihood integrator which integrates a likelihood of a function based on history and a likelihood of the function predetermined in accordance with the situation based on the weighting values of the weighting amount determinator; and
an output device which presents a function candidate based on the likelihood of the function integrated by the likelihood integration unit.

10. The function candidate presentation device according to claim 9,
wherein the weighting amount determinator determines the weighting values based on at least one piece of information of a time passed from a start of travelling of the vehicle, a road type of a road where the vehicle is currently travelling on, time passed from the start of travelling on respective road types, the number of uses from a start of use by a user, and experience of travelling on the travelling road.

11. The function candidate presentation device according to claim 9,
wherein the weighting amount determinator determines the weighting values based on at least one piece of information of a time period in a day, a day of the week, and a period in a year.

12. The function candidate presentation device according to claim 9,
wherein as the history, other user's history is included.

13. The function candidate presentation device according to claim 9,
wherein the situation includes at least one of a vehicle state and season.

14. The function candidate presentation device according to claim 9,
wherein the situation includes a driver state.

15. The function candidate presentation device according to claim 14,
wherein the driver state includes at least one of a sight line focusing part, autonomic nervous activity, and proficiency of driving.
